(19) United States
(12) Patent Application Publication
(10) Pub. No.: US 2021/0138680 A1
(43) Pub. Date: May 13, 2021

(54) METHOD FOR PRINTING AND AUTOMATICALLY CUTTING A TEXTILE SHEET

(71) Applicant: MORGAN TECNICA S.P.A, Adro (IT)

(72) Inventor: Fabrizio GIACHETTI, Adro (IT)

(21) Appl. No.: 16/629,493

(22) PCT Filed: Jul. 10, 2018
(86) PCT No.: PCT/IT2018/050127

§ 371 Date: Jan. 8, 2020

(30) Foreign Application Priority Data
Jul. 14, 2017 (IT) 102017000079792

(51) Int. Cl. B26F 1/38; D06H 1/02; D06H 7/24; B26D 5/00

(52) U.S. Cl. CPC B26F 1/3813; B26D 5/007; D06H 7/24; D06H 1/02

(57) ABSTRACT

A method for printing and automatically cutting a textile sheet (10) includes printing a plurality of patterns (11) on the textile sheet (10), and printing markings (23, 23′, 24, 24′) on the textile sheet (10). The markings represent useful information for automatic cutting and/or for treatment of the textile sheet and/or of the cut patterns (12). The markings are printed using an ink that is substantially invisible to the human eye and has an emission peak at a wavelength greater than 700 nm. The printed markings (23, 23′, 24, 24′) are detected and the information from the detected markings is obtained to carry out the automatic cutting and/or the treatment as a function of the obtained information.

### TECHNICAL FIELD OF THE INVENTION

The present invention relates to a method for printing and automatically cutting a textile sheet (i.e. a sheet of fabric or any other soft material in sheets such as synthetic or natural leather, non-woven fabrics, technical fabrics, composite materials, expanded materials such as latex foam, etc).

### STATE OF THE ART

There are known machines for the automatic cutting of fabrics that cut a textile sheet or a stack of overlapping textile sheets (in the jargon called ‘fabric lays’) to typically obtain a plurality of patterns according to the pre-set cutting design. Said patterns are then used to build a variety of products, such as items of clothing, footwear, furniture coverings or car interiors, upholstery, etc.

U.S. Pat. No. 9,623,578 B1 discloses a method of printing and subsequent automatically cutting a textile sheet, in which washable and ultraviolet reflective inks (UV inks) are printed on a textile sheet and captured in images by cameras comprising UV-light sources which project UV light onto the textile sheet and image sensors suitable for capturing the reflected ultraviolet (UV) light.

### SUMMARY OF THE INVENTION

The Applicant has realized that it may be convenient, under certain circumstances, to print on the textile sheet markings representative of useful and/or necessary information for the subsequent treatment of the textile sheet itself and/or of the cut patterns, including for example fixing, ironing, handling and/or manipulation of the textile sheet, and/or cutting, handling, manipulation, assembly, ironing, or destination of the cut patterns. Said markings may be, for example, markers representing the position and/or of the orientation in the space of the textile sheet or of the patterns, lines representing the cutting contour of the patterns, markings (e.g. alphanumeric codes, barcodes, QR codes, etc) univocally identifying the patterns, markings (e.g. written text, symbols, etc) representing instructions for the treatment of the patterns, such as destination, assembly, packaging instructions etc.

For example, the Applicant has observed that because typically the textile sheet is flexible and/or elastic, it can undergo various deformations during the printing and/or cutting process (e.g. stretchings or compressions, formation of ripples, etc.). According to the Applicant it is therefore convenient that during printing it is printed a marking (for example a line) representative of the cutting contour of each pattern, so that even in the presence of misalignments and/or deformations of the sheet, the cutting machine can recognize this contour and correctly cut the pattern along the cutting contour. The Applicant has observed that the printing of such markings with an ink visible to the human eye involves the need to print them outside the patterns, in order to avoid undesirable imperfections on the final products. In turn, this produces a waste of fabric, as the patterns must be spaced from one another in the printing and/or cutting design in order to allow the necessary space for said markings.

For example, to obviate the aforesaid aesthetic problem, the Applicant has envisaged to print, by visible ink, a marking, representative of the aforesaid cutting contour, on the textile sheet externally to the pattern, for example a line (continuous or discontinuous) drawn at a predetermined distance from the actual cutting contour. However, the Applicant has found that such a solution would produce an increase in the waste of fabric, since the patterns should be more widely spaced from one another in the cutting design to allow drawing of the aforesaid external contour.

The Applicant has also envisaged the possibility of printing said markings by inks invisible to the human eye under normal lighting conditions, which, on the contrary, emit in the visible by fluorescence when excited with UV radiation, thus becoming visible.

For example, the Applicant has contemplated the possibility of drawing the cutting contour of each pattern by printing with said inks. In this way, suitable cameras under suitable lighting conditions can detect this drawing which is then used to accordingly control the automatic cutting. However, in this case the Applicant has found that if the ink remains on the contour or inside the cut pattern, it may become visible to the human eye by fluorescence under particular lighting conditions (for example in the presence of illumination with a prevailing UV component, such as in public places like clubs or similar), with evident imperfection.

Furthermore, the printing of these markings with the aforesaid invisible ink externally to the pattern has the same problems regarding waste of fabric as highlighted above with reference to the use of visible ink.

The Applicant has therefore faced the problem of printing and automatically cutting a textile sheet in order to avoid any imperfection under all the lighting conditions to which the final product is typically subjected, while at the same time limiting to the minimum the waste of fabric which is between the patterns in the printing and/or cutting design.

One or more of the aforesaid problems is solved by a method for printing and automatically cutting a textile sheet according to the present invention in its various embodiments, as specified below and/or according to what is claimed in the attached claims.

According to an aspect the invention relates to a method for printing and automatically cutting a textile sheet, the method comprising:
arranging a textile sheet;
printing a plurality of patterns on said textile sheet;
automatically cutting said plurality of patterns on said textile sheet;
   wherein printing the plurality of patterns comprises printing markings on said textile sheet, said markings representing useful information for said automatic cutting and/or for treatment of said textile sheet and/or of said cut patterns, said markings also being printed using an ink that is substantially invisible to the human eye and having an emission peak at a wavelength greater than 700 nm,

and wherein the method comprises detecting said printed markings, obtaining said information from said detected markings and carrying out said automatic cutting and/or said treatment as a function of said obtained information.

By emission peak it is meant the wavelength at which the emission spectrum of the ink has an absolute maximum.

By ‘substantially invisible’ it is meant that under normal lighting conditions (sunlight or artificial lighting in the visible spectrum), the ink does not emit and/or reflect and/or diffuse light radiation in the visible spectrum to be easily visible to the human eye. This definition does not exclude that the ink has a certain emission and/or reflection and/or diffusion in the visible spectrum, however it is sufficiently low that it is not easily visible.

By visible spectrum it is meant the electromagnetic band having wavelength between about 400 nm and about 700 nm.

According to the Applicant, the above features, in particular the use of invisible inks and with an emission peak at wavelengths longer than those of the visible spectrum, makes these printed markings completely or substantially invisible to the naked human eye, namely without the aid of optical devices, such as filters, etc, and/or optoelectronics devices, such as IR sensors, etc, under substantially all lighting and/or vision conditions in which the finished product will typically be, and at the same time makes these markings easily detectable with appropriate lighting and detection systems. In this way it is possible to print these markings both internally and externally to the patterns, without leaving any imperfections on the finished product, and at the same time without necessarily having to move the patterns away from each other in the printing and/or cutting design. Furthermore, the lighting and/or detection systems suitable for these invisible inks can be simple and/or cheap and/or easily available and/or safe in terms of health and hygiene for people.

The present invention in one or more of its aspects may have one or more of the following preferred features.

By fabric it is meant any soft material in sheets such as fabrics properly meant, non-woven fabrics, technical fabrics, composite materials, synthetic or natural leather, expanded materials such as latex foam, etc.

Preferably said ink has an emission peak at a wavelength greater than or equal to 720 nm, more preferably greater than or equal to 750 nm. In this way the ink is even more difficult to see with the naked eye.

Preferably said ink has an emission peak at a wavelength less than 2500 nm, more preferably less than or equal to 2000 nm. In this way the ink detection technology is even easier and more accessible.

Preferably said ink has an absorption peak at a wavelength greater than or equal to 700 nm, more preferably greater than or equal to 725 nm, even more preferably greater than or equal to 750 nm. In this way the ink is even more difficult to see because it requires an excitation with infrared radiation.

By absorption peak it is meant the wavelength at which the absorption/excitation spectrum of the ink has an absolute maximum.

Preferably said markings comprise one or more of the following markings: markers representing a position and/or orientation in the space of the textile sheet or of the patterns, markings representing a cutting contour for cutting out the patterns, markings (e.g. alphanumeric codes, barcodes, QR codes, etc) uniquely identifying the patterns, markings (e.g. written text, symbols, etc) representing instructions for treatment of the patterns, such as destination, assembly, packaging instructions etc.

Preferably said markings comprise a marking representing cutting contours for cutting out the patterns, more preferably a line (continuous or discontinuous), even more preferably drawn above, or at a predetermined distance from, said cutting contours, internally to said patterns. According to the Applicant, this marking is particularly useful for overcoming the problem of the displacement and/or deformation of the cutting sheet after the printing and before or during the automatic cutting. Thanks to the recognition of this marking, the automatic cutting can be controlled following the desired cutting contour, regardless of the position and/or orientation of the sheet on the cutting plane and/or regardless of its possible deformations.

Preferably said markings, more preferably said markings representing a cutting contour for cutting out the patterns and/or said markings uniquely identifying the patterns and/or said markings representing instructions for treatment of the patterns, are at least partially printed, more preferably are entirely printed, within, or on, cutting contours for cutting out said patterns. In this way, the markings advantageously remain on the patterns even after the cutting, being therefore available for the subsequent production steps, without giving any imperfection to the final product.

Preferably detecting said printed markings comprises acquiring images of said printed textile sheet using sensors sensitive to radiation with wavelengths greater than 700 nm. Said sensors are capable of detecting the used ink.

Preferably acquiring said images comprises filtering incident radiation on said sensors using an infrared band pass optical filter, namely a filter configured to block the visible radiation and to allow the radiation with a wavelength greater than 700 nm, more preferably greater than or equal to 750 nm, to pass.

Further features and advantages of the present invention will become clearer from the indicative, and therefore non-limiting, description of some preferred but not exclusive embodiments of the present invention.

### BRIEF DESCRIPTION OF THE FIGURES

This description will make use of the combined figures in which:

FIG. 1 schematically shows a perspective view of a machine for printing and automatically cutting according to the present invention;

FIGS. 2 and 3, in a purely illustrative way, show examples of printed patterns according to the present invention.

### DETAILED DESCRIPTION OF SOME EMBODIMENTS OF THE INVENTION

A machine 1 for printing and automatically cutting a textile sheet 10 comprises a machine 2 for printing the textile sheet 10 and a machine 3 for automatically cutting the textile sheet 10, which can be integrated together, as shown in the figure, or physically 3 0 separated.

The printing and cutting machines 2, 3 are not shown and described in detail since they can, for example, be of the known type. For example, the printing machine 2 typically includes a print head (not shown), for example with ink-jet technology, which can be moved parallel to the printing plane 4 along the two X and Y axes shown in the figure. For example, the cutting machine 3 typically comprises a cutting head 5 (shown only schematically as, for example, of known type) in an overlying position with respect to a cutting plane 6. The machine 1 typically comprises a movement system 7 of the cutting head along the X and Y axes parallel to the cutting plane 6.

Exemplarly, the printing plane 4 and/or the cutting plane 6 is/are made of a (preferably single) conveyor belt 8 on whose upper face the textile sheet 10 is supported, the belt 8 being able to advance, with continuity and/or discrete steps, the textile sheet 10 from the printing machine 2 directly to the cutting machine 3.

The automatic cutting machine 3 preferably comprises an image acquisition system 20, comprising one or more cameras 21. In the shown example, the image acquisition system 20 comprises two cameras 21 placed at two corners of the plain of the cutting plane 6. Preferably, the image acquisition system 20 comprises a further camera (not shown) mounted on the cutting head, capable of acquiring close-up images of the cutting area.

Preferably each camera of the image acquisition system 20 comprises a sensor sensitive at least to the infrared radiations, in particular to the near infrared radiations (wavelength greater than 700 nm and less than about 2500 nm). Optionally each camera of the image acquisition system 20 comprises one or more optical filters, for example a band pass filter of the infrared band.

Optionally, the automatic cutting machine 3 can comprise a lighting system 30 (only schematically shown), capable of illuminating the textile sheet 10 resting on the cutting plane 6 with a suitable radiation, for example with radiation in the near infrared, in order to excite the used IR ink.

Typically, the printing machine 2 and the cutting machine 3 comprise a respective controller 9, configured and programmed to command and control the respective operations. In the shown example, a single controller 9 integrates the respective controllers for the two machines 2 and 3 in a single device, however the two respective controllers may alternatively be, in whole or in part, distinct and/or physically separated. Each controller can be made from any appropriate combination of hardware and software.

During operation, the machine 1 for printing and cutting a textile sheet 10 can implement the method of the present invention.

For this purpose, a single textile sheet 10 is at first fed to the printing machine 2. For example, the textile sheet 10 can be unrolled (continuously or with discrete steps) from a roll of fabric (not shown) and forward dragged along the Y direction on the printing plane 4 by the conveyor belt 8.

Typically, the textile sheet is in solid colour, for example white or neutral colour, to be able to suitably receive the colour during printing.

When the textile sheet 10 is on the printing plane 4, the printing machine 2 provides for printing the fabric of the textile sheet 10 according to a printing design loaded in the respective controller 9. The printing design typically provides a plurality of patterns 11.

After printing, the textile sheet 10 is moved towards the cutting plane 6, for example by means of the conveyor belt 8, to be automatically cut by the cutting machine 3 to obtain a plurality of cut patterns 12.

According to the invention, during the printing, on the textile sheet 10 there are printed markings representing information useful for the automatic cutting and/or for the treatment (following the printing) of the textile sheet and/or of the cut patterns. FIGS. 2 and 3 show two examples of a pattern 11 printed on the sheet 10 according to the present invention.

Optionally, but not necessarily, the printing process involves the drafting, with an ink visible to the human eye, of a desired printing scheme 21, consisting for example in a solid colour or in a coloured design and/or in writings and/or in coloured images.

The number 22 indicates the actual cutting contour of the pattern, that is the line along which the automatic cut must ideally be carried out to form the pattern 12 of the desired shape and dimensions.

Exemplarily, although not necessarily, this cutting contour 22 coincides with the perimeter of the printing scheme 21, although it may be advantageous to print the printing scheme 21 slightly more abundant than the cutting contour (in order to take into account the printing and/or cutting tolerances).

In the absence of further expedients (such as those described below), the perimeter of the printing scheme 21 is difficult to identify by processing of the images acquired by the image acquisition system 20, at least under some conditions, such as in the case of low contrast between the colour of the printing scheme 21 and the background fabric 10. In this case it is not possible to identify the exact position and shape of the cutting contour 22 when the textile sheet 10 is on the cutting plane 6, with consequent difficulty and/or imprecision in performing the automatic cutting.

As shown in FIGS. 2 and 3, during printing it is preferably printed on the textile sheet 10 a line 23, 23′ (which may be continuous or discontinuous) representing the cutting contour 22. This line can be printed exactly (not shown) on the cutting contour 22, or externally to the cutting contour 22 (as shown in FIG. 2) or internally to the cutting contour 22 (as shown in FIG. 3), for example at a predetermined distance (e.g. of a few mm) from the actual cutting contour 22. Thanks to the detection and identification of this line 23, 23′, the automatic cutting can be controlled following the desired cutting contour 22, regardless of the position and/or orientation of the sheet on the cutting plane and/or its possible deformations.

As shown in FIGS. 2 and 3, during the printing, further markings 24, 24′ are preferably printed on the textile sheet 10, said further markings representing useful information for the treatment (following the printing) of the cut patterns. Said further markings 24, 24′ can for example consist of text and/or symbols and/or codes (barcodes, QR codes, etc.) representing, for example, useful information for univocally identifying the respective pattern after the cut (namely labelling of the patterns) and/or useful information for identifying the properties of the respective pattern (lot, type of fabric, etc) and/or useful information for providing operators with instructions for assembling and/or processing the respective pattern.

According to the present invention, the aforesaid markings 23, 23′, 24, 24′ are printed with an ink invisible to the human eye and having an emission peak at a wavelength greater than 700 nm, i.e. in the infrared, preferably in the near infrared (up to 2500 nm). Such IR inks, for example of known type, typically contain fluorescent materials (organic or inorganic), i.e. materials capable of absorbing a light radiation at a first peak wavelength and emitting a light radiation at a second peak wavelength. The absorption/excitation and emission spectra can have any shape and present, in addition to the aforesaid absorption/excitation peaks, further relative maxima.

Typically, the second wavelength is greater than the first (‘down-conversion’), although there may be materials capable of implementing a so-called ‘up-conversion’. IR inks can have an absorption peak in the visible or, preferably, in the near infrared.

According to a first example of ink, the absorption peak is located at 793 nm, while the emission peak is at 840 nm.

According to a second example of ink, the absorption peak is located at 824 nm, while the emission peak is at 885 nm.

In case of organic materials, typically the IR ink degrades rapidly (within a few days) if subjected to UV radiation.

The method according to the present invention comprises detecting the aforesaid markings 23, 23′, 24, 24′ printed with IR ink, obtaining the aforesaid information from the detected markings and performing the automatic cutting and/or the subsequent treatment according to the obtained information. For this purpose, for example, the image acquisition system 20 acquires appropriate images of the printed textile sheet 10 thanks to the infrared sensitive sensors, capable of detecting the IR ink. Optionally, said image acquisition takes place under suitable lighting conditions by the lighting system 30, for example by illuminating the textile sheet 10 with a radiation having wavelength equal or near to the absorption/excitation peak of the used IR ink.

Preferably the aforesaid markings 23, 24 printed with IR ink are at least partially, more preferably entirely, printed inside, or on, the respective cutting contour 22 of the pattern, as exemplified in FIG. 3. From the comparison with FIG. 2, where the aforesaid markings 23′, 24′ are printed externally to the cutting contour 22 of the pattern, there are evident both the reduction of waste of fabric 10 and the advantage that the markings 24 remain on the patterns even after the cutting, without giving any imperfection to the final product.

1. A method for printing and automatically cutting a textile sheet, said method comprising:
arranging a textile sheet;
printing a plurality of patterns on said textile sheet;
automatically cutting said plurality of patterns on said textile sheet;
wherein printing the plurality of patterns comprises printing markings on said textile sheet, said markings representing useful information for said automatic cutting and/or for treatment of said textile sheet and/or of said cut patterns, said markings also being printed using an ink that is substantially invisible to the human eye and having an emission peak at a wavelength greater than 700 nm, and
detecting said printed markings; obtaining said information from said detected markings and carrying out said automatic cutting and/or said treatment as a function of said obtained information.

2. The method according to claim 1, wherein said ink has an emission peak at a wavelength greater than or equal to 720 nm, and/or less than 2500 nm.

3. The method according to claim 1, wherein said ink has an absorption peak at a wavelength greater than or equal to 700 nm.

4. The method according to claim 1, wherein said markings comprise one or more of the following markings: markers representing a position and/or orientation in the space of the textile sheet or of the patterns, markings representing a cutting contour for cutting out the patterns, markings uniquely identifying the patterns, and markings representing instructions for treatment of the patterns.

5. The method according to claim 4, wherein said markings representing a cutting contour for cutting out said patterns consist in comprise a line marked out on, or at a predetermined distance from, said cutting contours.

6. The method according to claim 4, wherein said markings representing a cutting contour for cutting out the patterns and/or said markings uniquely identifying the patterns and/or said markings representing instructions for treatment of the patterns, are at least partially printed within, or on, cutting contours for cutting out said patterns.

7. The method according to claim 4, wherein said markings representing a cutting contour for cutting out the patterns and/or said markings uniquely identifying the patterns and/or said markings representing instructions for treatment of the patterns, are entirely printed within, or on, cutting contours for cutting out said patterns.

8. The method according to claim 1, wherein detecting said printed markings comprises acquiring images of said printed textile sheet using sensors sensitive to radiation with wavelengths greater than 700 nm.

9. The method according to claim 1, wherein acquiring said images comprises filtering incident radiation on said sensors using an optical filter configured to block visible radiation and to allow radiation with a wavelength greater than 700 nm to pass.

10. The method according to claim 1, wherein said ink has an emission peak at a wavelength greater than or equal to 750 nm, and/or less than 2500 nm, and less than or equal to 2500 nm.

11. The method according to claim 10, wherein said ink has an emission peak at a wavelength less than or equal to 2000 nm.

12. The method according to claim 1, wherein said ink has an absorption peak at a wavelength greater than or equal to 725 nm.
